(19) United States
(12) Patent Application Publication
(10) Pub. No.: US 2007/0033036 A1
(43) Pub. Date: Feb. 8, 2007

(54) Automatic detection and research of novel words or phrases by a mobile terminal

(75) Inventor: Guru Corattur Sambandam Guruparan, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobil Communications AB

(21) Appl. No.: 11/184,470

(22) Filed: Jul. 19, 2005

(51) Int. Cl. G10L 15/04

(52) U.S. Cl. 704/251

(57) ABSTRACT

A wireless communication system mobile terminal monitors its acoustic environment. Speech recognition capability in the mobile terminal transcribes monitored speech, and determines if it is novel, such as by comparison to a database of known words and phrases. Terms from the determined novel speech are submitted to one or more information resources, such as search engine, dictionary, encyclopedia, or new word/phrase server web sites. The highest-ranked returned links may be followed and the resulting pages downloaded to the mobile terminal over a low bandwidth channel for review by a user. If a user does not access the downloaded information within a predetermined time period, it is deleted.

### BACKGROUND

The present invention relates generally to the field of wireless communication and in particular to detecting and researching novel words or phrases by a mobile terminal.

All languages evolve. Familiar words and phrases take on new meanings over time. In addition, “slang,” patois, and idioms arise and morph faster than conventional dictionaries can track them. Modern information resources such as the Internet help individuals keep abreast of popular linguistic evolution. As one example, many web sites define or explain new words or phrases, and may provide background material relating to their etymology, including in some cases the social, cultural, and political background giving rise to the expressions. By accessing these resources, individuals may educate themselves as to the meaning and usage of the newly encountered words or phrases.

Individuals encounter new words and phrases in conversation in a variety of contexts. In many cases, individuals may not wish to admit to unfamiliarity with new terms or expressions, and may resolve to investigate the language later. For example, an individual may wait until he has access to a personal computer or other terminal to access Internet web sites to research newly encountered words or phrases. With the advent of data communications and Internet connectivity on cellular telephonic networks, users may access such Internet web sites via a wireless communication system mobile terminal immediately following a conversation in which unknown words or phrases are encountered. However, even this convenience requires active “surfing” on the part of the user, and will often incur air time charges, as the user requires a relatively high bandwidth connection to provide a satisfying interaction, with sufficiently short download times for relevant information located via the browsing capabilities of the mobile terminal.

A device that monitors a user's conversations, detects novel words or phrases, researches the novel speech, and provides the user information relating the determined novel speech—without user intervention—would be advantageous.

### SUMMARY

A wireless communication system mobile terminal monitors its acoustic environment. Speech recognition capability in the mobile terminal transcribes monitored speech, and determines if it is novel. Terms from the determined novel speech are submitted to one or more information resources, such as search engine, dictionary, or encyclopedia web sites. The highest-ranked returned links may be followed and the resulting pages downloaded to the mobile terminal for review by a user. If a user does not access the downloaded information within a predetermined time period, it is deleted.

In one embodiment, the present invention relates to a method of automatically researching novel words or phrases by a mobile terminal without user intervention. The acoustic environment of the mobile terminal is monitored. Monitored speech is transcribed using voice recognition capability in the mobile terminal. The mobile terminal determines that transcribed speech is novel. One or more information resources are accessed and information related to the novel speech is downloaded.

In another embodiment, the present invention relates to a mobile terminal. The mobile terminal includes a transceiver operative to communicate data over a wireless communication system and an acoustic sensor operative to monitor the acoustic environment of the mobile terminal. The mobile terminal further includes means for transcribing monitored speech and a controller. The controller is operative to determine that transcribed speech is novel, and further is operative to access one or more information resources via a wireless communication system and to download information related to the determined novel speech.

### BRIEF DESCRIPTION OF DRAWINGS

FIG. 1 is a functional block diagram of a mobile terminal connected to wireless communication networks, and connected through the network to information resources, such as on the Internet.

FIG. 2 is a flow diagram of a method of automatically researching novel words or phrases by a mobile terminal.

FIG. 3 is a functional block diagram of a mobile terminal with speech recognition capability.

### DETAILED DESCRIPTION

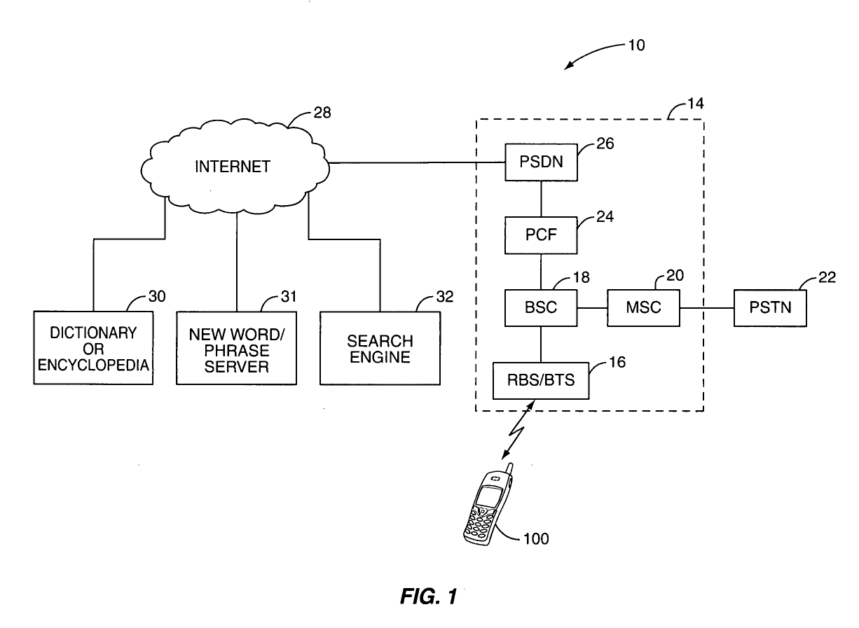

FIG. 1 depicts a representative, interconnected wired/wireless communication system, indicated generally by the numeral 10. A mobile terminal 100 communicates with a wireless communication system 14. The wireless communication system 14 may operate according to any of a variety of industry standard protocols, such as such as a CDMA, WCDMA, GSM/GPRS, EDGE, or UMTS, as known in the art.

The wireless communication system 14 includes a Radio Base Station (RBS) 16, also known as a Base Transceiver Station (BTS) that controls and manages the wireless link to the mobile terminal 100. The RBS/BTS 16 connects to and operates under the control of a Base Station Controller (BSC) 18. A BSC 18 may control a plurality of RBS/BTS 16 (not shown). Telephonic communications from the mobile terminal 100 may be routed from the BSC 18 to a Mobile Switching Center (MSC) 20, for routing to another mobile terminal 100 or to a landline telephone in the Public Switch Telephone Network (PSTN) 22. The BSC 18 may additionally be connected to a Packet Control Facility (PCF) 24, which in turn may interface to a variety of packet data switched networks, such as the Internet 28, via a Packet Data Switching Node (PDSN) 26. FIG. 1 is representative only; the structure and operation of wireless communication systems 14 are well known to those of skill in the art, and are not further elaborated herein.

As well known in the art, a wide variety of information resources, such as web sites, are available on the Internet 28. Representative of types or classes of web sites are a dictionary or encyclopedia web site 30, new words/phrases server 31, and search engine 32. The Internet 28 and web sites 30, 31, 32 are representative only. In other embodiments, the wireless network 14 may connect via a PDSN 26 to a different packet-switched network 28, connecting to different information resources 30, 31, 32.

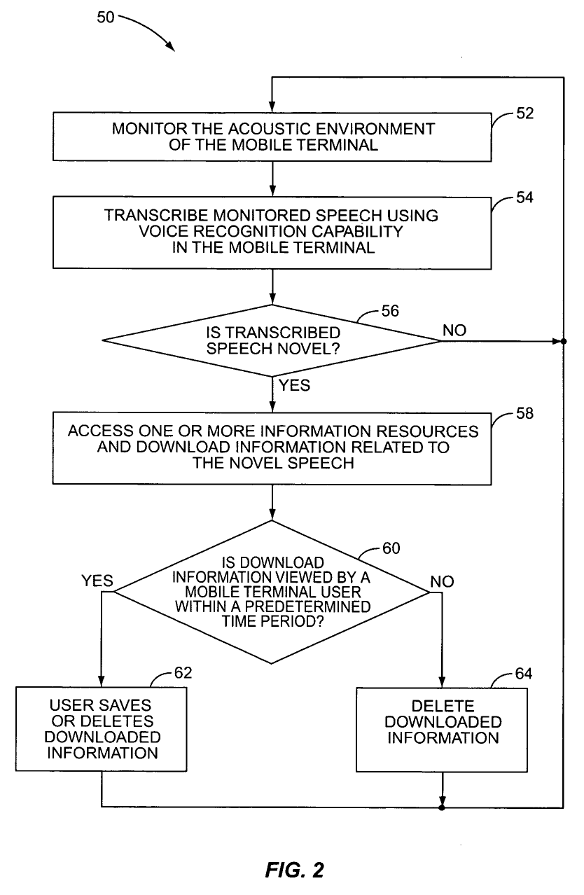

According to one or more embodiments of the present invention, the mobile terminal 100 automatically researches novel words or phrases uttered within its acoustic environment, without user intervention. A method of performing this is depicted in flow diagram form in FIG. 2, indicated generally by the numeral 50. The mobile terminal 100 includes an acoustic sensor, such as a microphone, operative to monitor its acoustic environment. That is, the mobile terminal 100 monitors sounds in the area around the mobile terminal 100, such as voice conversations (block 52). Using built-in speech recognition capability, the mobile terminal continuously transcribes speech monitored from the acoustic environment, transforming the audible speech into individual words and phrases (block 54). As described in detail herein, in various embodiments, the speech recognition capability may comprise speech recognition software, a hardware speech recognition engine, or some combination.

The mobile terminal 100 determines whether speech transcribed from its acoustic environment includes novel words and phrases (block 56). In one embodiment, the mobile terminal 100 compares transcribed words and phrases to a database of common words and phrases. If the transcribed words and phrases are found in the database, they are not deemed novel, and the mobile terminal 100 continues to monitor the acoustic environment for new speech (block 52). If the transcribed words and phrases are not found in the database, the mobile terminal 100 determines that they may be novel, and accesses one or more information resources for information regarding the novel speech (block 58). The information resources access is preferably performed as a background task, using a low bit rate. In one embodiment, the information resources accessed may comprise web sites 30, 31, 32 connected to the Internet 28 (FIG. 1).

One type of web site 30, 31, 32 that the mobile terminal 100 may access for information regarding the novel speech is a search engine 32. In particular, the mobile terminal 100 may provide one or more words, or part or all of a phrase, determined to be novel, as search terms for the search engine 32. The search engine 32 may comprise a generic search engine, such as google.com, that searches a database of web sites collected from all over the Internet 28. Another type of search engine 32 is a pay-per-click (PPC) search engine, such as yahoo.com, that searches a database of sponsored web sites (that is, a sponsor listed the web site in the database, and pays the search engine 32 operator for traffic to the web site that originates from the search engine 32).

The mobile terminal may download information related to the novel speech from the information resource such as search engine 32 (block 58). Search engines 32 generally rank their search results by various criteria, such as relevance to the search terms, the popularity of the sites in the search results, information gleaned about the user initiating the search, and the like. The goal of search result ordering is generally to present the search results most likely to be most relevant to the user, highest in the list, with other search results listed in decreasing order of assumed relevance. In one embodiment, the mobile terminal accesses the first n links listed in an ordered list of search results, where n is a positive integer. In one embodiment, the user of the mobile terminal 100 may specify the value n.

The information resources, such as web sites, accessed by following the first n links in the ordered search results list are downloaded for review by the mobile terminal 100 user, to provide information about the determined novel words or phrases (block 58). The download is preferably performed over a low bandwidth channel, as a background task. This may reduce or eliminate airtime charges associated with use of a high bandwidth channel.

The user may then access the downloaded information at his discretion, for example, immediately after completing the conversation in which the novel words or phrases were encountered. In this manner, the mobile terminal 100 “anticipates” the user's information needs, and allows the user to resolve the meaning (if any) of the novel words and phrases encountered, without the need to explicitly access information resources and search for it.

Another type of web site 30, 31, 32 that the mobile terminal 100 may access for information regarding the novel speech is a dictionary or encyclopedia web site 30. An example of a conventional dictionary web site 30 is dictionary.com, which returns dictionary definitions for words and phrases entered for look-up. Another dictionary-type site 30, which may of particular relevance to the present invention, is urbandictionary.com. This site allows visitors to provide definitions and descriptions for slang terms and idiomatic expressions, and functions in a look-up mode similarly to a conventional dictionary site 30.

Functionally similar to a dictionary site 30 is an encyclopedia site 30—the primary difference being the amount and depth of information returned for a word or phrase entered for look-up. An example of an encyclopedia site 30 is wikipedia.org. In general, the determined novel words and phrases transcribed from speech in the acoustic environment of the mobile terminal 100 may be entered as look-up terms in dictionary or encyclopedia web sites 30. Also, as described above, where plural results are returned in an ordered list, the highest n ranked results may be accessed, where n is a positive integer that may be user-selectable.

Another representative example of an information resource 30, 31, 32 that the mobile terminal 100 may access upon encountering a novel word or phrase is a new words/phrases server 31. The new words/phrases server 31 may comprise a special server that receives determined novel words and phrases from mobile terminals 100, and accesses a database of new words and phrases, returning information relevant to the determined novel words and phrases to the mobile terminals 100. The database may be maintained by monitoring social and linguistic trends, and entering new words and phrases as they become prevalent in general use.

Regardless of the information source 30, 31, 32 consulted, if the mobile terminal 100 user accesses the downloaded information related to the determined novel speech within a predetermined time period (block 60), the user may save, delete, or transfer the information from the mobile terminal 100, as desired (block 62). If the user does not access the downloaded information related to the determined novel speech within the predetermined time period (block 60), the downloaded information may be deleted (block 64). In this case, it may be assumed that, while monitored, transcribed speech was determined novel by the mobile terminal 100, the words or phrases were not sufficiently novel to the user to prompt him to access the downloaded information. In either case, the mobile terminal 100 continues to monitor its acoustic environment for more potentially novel speech (block 52).

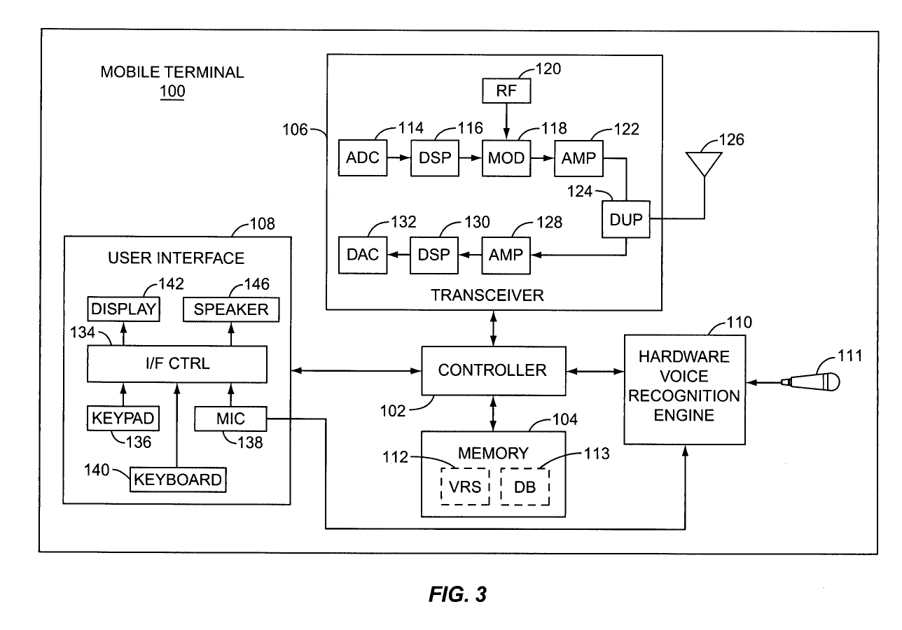

FIG. 3 depicts a functional block diagram of a mobile terminal 100 having speech recognition capability. The mobile terminal 100 includes a controller 102, memory 104, a transceiver 106, user interface 108, and voice recognition capability, either in the form of a hardware voice recognition engine 110 or Voice Recognition Software (VSR) 112.

The controller 102 is a stored program microprocessor, microcontroller, digital signal processor, or the like as well known in the art. The controller 102 controls the overall operation of the mobile terminal 100, executing programs from memory 104, which may comprise RAM (SRAM, DRAM, SDRAM, FLASH, etc.), ROM (PROM, EPROM, EEPROM, etc.), and magnetic or optical media. In particular, in one embodiment, the controller 102 (or alternatively, another processor in the mobile terminal 100) executes Voice Recognition Software (VSR) 112 to transcribe monitored speech from the mobile terminal's acoustic environment. The controller is further operative to determine novel speech by comparing monitored words and phrases with a database 113 of known words and phrases.

The transceiver 106 includes transmit and receive circuits necessary to effect two-way voice and data communication across a wireless communication link 12. The transmitter chain includes an Analog to Digital Converter (ADC) 114 to convert voice signals to digital format; a Digital Signal Processor (DSP) 116 to encode the digital voice and/or data; a modulator 118, receiving a Radio Frequency (RF) signal from an oscillator 120, for modulating the encoded signal onto an RF carrier; and a power amplifier 122. The encoded, modulated, amplified signal is routed by a duplexer 124 to an antenna 126 for transmission to a RBS/BTS 16. In the receiver chain, signals received by the antenna 126 from a RBS/BTS 16 are routed by the duplexer 124 to a Low Noise Amplifier (LNA) 128; a Digital Signal Processor (DSP) 130 for demodulation, decoding, and baseband processing; and Digital to Analog Converter 132 for converting digitally encoded speech signals into audible signals. The transceiver 106 includes all circuits and functionality necessary to comprise a fully functional duplex wireless transceiver in accordance with the protocol of the wireless communication system 14.

The user interface 108 accepts from, and provides output to, the user of the mobile terminal 100. An interface controller 134 accepts input from at least a keypad 136 and a microphone 138. The mobile terminal 100 may additionally include a full or partial alphanumeric keyboard 140, which also provides input to the interface controller 134. The interface controller 134 directs visual output to a display 142 and audio output to one or more speakers 146. The user may access the user interface 108 to control the operation of the mobile terminal 100, enter telephone numbers, navigate menus, and the like. Additionally, the user may utilize the user interface 108 to directly access information sources such as web sites 30, 31, 32.

In one embodiment, the microphone 138 accepts speech input by a user for a telephonic conversation, and additionally monitors the acoustic environment of the mobile terminal 100 for potentially novel speech. In another embodiment, the microphone 138 is dedicated to user voice input, and another acoustic sensor, such as a second microphone 111, monitors the acoustic environment. In this embodiment, the acoustic sensor 111 may be located on the housing of the mobile terminal 100 in a position that is optimal for such monitoring, but not optimal for picking up user speech for telephonic conversation.

Acoustic signals from the microphones 138, 111 may be amplified and digitized by the interface control logic 134, and then passed to the controller 102 (or other processor in the mobile terminal 100) for processing. The controller 102 may send the digitized acoustic signals to a hardware voice recognition engine 110 for processing to transcribe voice content in the acoustic signals to textual words or phrases. Alternatively, the output of microphones 138, 111 may be routed directly as inputs to the hardware voice recognition engine 110. The hardware voice recognition engine 110 may comprise custom logic circuits, such as in an ASIC, FPGA, or the like. Alternatively, the hardware voice recognition engine 110 may comprise a dedicated DSP or other controller running software to perform the voice recognition. In either case, the hardware voice recognition engine 110 accepts acoustic signals (analog or digital), recognizes speech content in the signals, and transcribes the speech into words or phrases, which it passes to the controller 102 for novelty processing.

In another embodiment, the output of microphones 138, 111 is digitized and provided to the controller 102, which executes Voice Recognition Software (VRS) 112 to recognize speech content in the acoustic signals, and to transcribe the speech into words or phrases. Those of skill in the art will recognize that various hybrid implementations of speech recognition capability in a mobile terminal 100, including hardware and software components, are possible within the broad scope of the present invention.

To determine if transcribed words or phrases are novel, in one implementation the controller 102 compares the words or phrases to a database 113 of known words and phrases. If the transcribed words or phrases match those found in the database 113, the transcribed speech may be determined not to be novel, and no research on its meaning is performed. If the transcribed words or phrases do not match any database 113 entries, the controller 102 may determine that the speech is novel, and may access information resources related to the determined novel speech via data transfers through the transceiver 106 to a wireless communication system 14. As depicted in FIG. 1, the wireless communication system 14 is operative to connect the mobile terminal 110 in data transfer relationship with one or more information resources, such as web sites 30, 31, 32 on the Internet 28. This allows the mobile terminal 100 to download the most relevant information related to the determined novel speech, such as for example the first n entries in an ordered list of search or look-up results.

Information related to the determined novel speech, downloaded from information resources such as web sites 30, 31, 32, may be stored in the mobile terminal 100, such as in memory 104 (which may include magnetic or optical disk storage). The user may be notified that the information is available, such as via an icon displayed on the display 142, an LED (not shown) or the like being illuminated, or some via some other notification mechanism. As well known in the art, the controller 102 maintains the current “wall clock” time, either provided by real-time clock logic (not shown), or provided as part of the extensive timing and synchronization overhead concomitant to communications with the wireless network 14. In one embodiment, if a user does not access the downloaded information related to determined novel speech within a predetermined time period, such as a few days, the downloaded information may be deleted. In one embodiment, the time period may be user-selectable, and its value stored in the memory 104. In this manner, information related to transcribed words and phrases that the user determines are not novel, as indicated by the user not viewing it, is automatically deleted.

By use of the mobile terminal 100 and/or method disclosed and claimed herein, a user may obtain information related to newly encountered, or novel, speech, automatically and immediately following his conversation. The user does not need to explicitly access the Internet 28 and to actively search for this information, and will not require the use of expensive, high bandwidth air interface resources to do so. Rather, the mobile terminal 100 acts in the manner of a “web crawler,” constantly detecting novel words and phrases, searching the Internet 28 for information related to them, and making that information available to the user, all without user intervention.

As used herein, the term “mobile terminal” may include a cellular radiotelephone with or without a multi-line display; a Personal Communications System (PCS) terminal that may combine a cellular radiotelephone with data processing, facsimile and data communications capabilities; a Personal Digital Assistant (PDA) that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of automatically researching novel words or phrases by a mobile terminal without user intervention, comprising:
monitoring the acoustic environment of the mobile terminal;
transcribing monitored speech using voice recognition capability in the mobile terminal;
determining that transcribed speech is novel; and
accessing one or more information resources and downloading information related to the novel speech.

2. The method of claim 1 wherein the voice recognition capability comprises voice recognition software running on the mobile terminal.

3. The method of claim 1 wherein the voice recognition capability comprises a hardware voice recognition engine in the mobile terminal.

4. The method of claim 1 wherein determining that transcribed speech is novel comprises comparing transcribed speech to a database of common words and phrases in the mobile terminal.

5. The method of claim 1 wherein accessing one or more information resources comprises accessing one or more Internet web sites.

6. The method of claim 5 wherein accessing one or more Internet web sites comprises accessing a search engine and initiating a search on the terms determined to be novel speech.

7. The method of claim 6 wherein downloading information related to the novel speech comprises accessing and downloading the n highest-ranked search results, where n is a predetermined positive integer.

8. The method of claim 5 wherein accessing one or more Internet web sites comprises accessing a dictionary or encyclopedia web site and initiating a look-up on the terms determined to be novel speech.

9. The method of claim 8 wherein downloading information related to the novel speech comprises accessing and downloading the n highest-ranked definitions or encyclopedia entries, where n is a predetermined positive integer.

10. The method of claim 5 wherein accessing one or more Internet web sites comprises accessing a server maintaining a database of topical new words and phrases, and initiating a look-up on the terms determined to be novel speech.

11. The method of claim 1 downloading information related to the novel speech comprises downloading the information over a low bandwidth channel of a wireless communication system.

12. The method of claim 11 wherein downloading the information proceeds as a background task of the mobile terminal.

13. The method of claim 1, further comprising displaying to a mobile terminal user the downloaded information related to the novel speech.

14. The method of claim 13, further comprising deleting the downloaded information related to the novel speech if the information is not accessed by a user within a predetermined time period.

15. The method of claim 14 wherein the predetermined time period is user-selectable.

16. A mobile terminal, comprising:
a transceiver operative to communicate data over a wireless communication system;
an acoustic sensor operative to monitor the acoustic environment of the mobile terminal;
means for transcribing monitored speech; and
a controller operative to determine that transcribed speech is novel, and further operative to access one or more information resources via the wireless communication system and download information related to the determined novel speech.

17. The mobile terminal of claim 16 wherein the means for transcribing monitored speech comprises voice recognition software running on a processor in the mobile terminal.

18. The mobile terminal of claim 16 wherein the means for transcribing monitored speech comprises a hardware voice recognition engine in the mobile terminal.

19. The mobile terminal of claim 16 further comprising a database of common words and phrases, and wherein the controller determines that transcribed speech is novel by comparison to the database.

20. The mobile terminal of claim 16 wherein one or more information resources comprise one or more Internet web sites.

21. The mobile terminal of claim 20 wherein one or more Internet web sites comprise one or more search engines.

22. The mobile terminal of claim 21 wherein the controller is operative to initiate a search on terms comprising the determined novel speech, and is further operative to download the n highest-ranked search results, where n is a predetermined positive integer.

23. The mobile terminal of claim 20 wherein one or more Internet web sites comprise one or more dictionary or encyclopedia web sites.

24. The mobile terminal of claim 23 wherein the controller is operative to initiate a look-up on terms comprising the determined novel speech, and is further operative to download the n highest-ranked definitions or encyclopedia entries, where n is a predetermined positive integer.

25. The mobile terminal of claim 20 wherein one or more Internet web sites comprise one or more new words/phrases server web sites.

26. The mobile terminal of claim 16 wherein the controller is further operative to download information related to the determined novel speech over a low bandwidth channel of the wireless communication system.

27. The mobile terminal of claim 26 wherein the controller is further operative to download the information as a background task.

28. The mobile terminal of claim 16 wherein the controller is further operative to display to a mobile terminal user the downloaded information related to the determined novel speech.

29. The mobile terminal of claim 16, wherein the controller is further operative to delete the downloaded information related to the determined novel speech if the information is not accessed by a user within a predetermined time period.

30. The mobile terminal of claim 29 wherein the predetermined time period is user-selectable.
